(19) United States
(12) Patent Application Publication
(10) Pub. No.: US 2008/0130887 A1
(43) Pub. Date: Jun. 5, 2008

(54) Secure Data Communication Apparatus and Method

(76) Inventors: Andrew M. Harvey, Edinburgh (GB); Colin Fraser, Edinburgh (GB)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 10/592,464

(22) PCT Filed: Mar. 10, 2005
(86) PCT No.: PCT/GB05/00928

§ 371 Date: Sep. 10, 2007

(30) Foreign Application Priority Data
Mar. 11, 2004 (GB) 0405573.7

(51) Int. Cl. H04K 1/00

(52) U.S. Cl. 380/256

(57) ABSTRACT

A secure data communication system configuration to encrypt the data to be transmitted within the random phase fluctuations of the field spectrum of a low temporal coherence source and to decrypt the data at the receiver through an autocorrelation technique. The optical field encryption technique disclosed herein uses a dual interferometer and has the advantages of being realisable with current technology allowing high data rates and opaqueness to an unwanted observer on the system upon which data is being transferred.

The present invention relates to a secure data communications apparatus and method and in particular to encrypted optical data communication systems.

Cryptography techniques commonly applied to optical communication networks rely on digital encryption of the data prior to optical transmission and subsequent digital post-detection decryption. The optical medium and optical field are used passively for communication of the encrypted message.

Practical Quantum Cryptography systems as described in the patent applications WO02/089396 and GB2378864 use quantum mechanical effects to encrypt the information optically. However, current quantum cryptography systems are expensive, prone to transmission errors, significantly restrict the optical data transmission rate of the system with communication distance, and are limited to point-to-point network topologies. Furthermore, elements of these systems are incompatible with currently installed optical link equipment across all the commercial optical communication markets.

In addition, the dual channel topology of a Quantum cryptography system is still based on the cryptography security principle of the Vernam cipher or one-time pad for the public channel. The Vernam cipher (Gilbert Vernam 1917) is the only mathematical proven secure cryptography algorithm to date, all other algorithms relying on computational security. If the low key distribution rate of a quantum cryptography system is not to limit the communication rate over the public channel, then the key will be employed many times. However, employing the same encryption key repeatedly, increases the likelihood of an unwanted observer decrypting the data on the public channel.

U.S. Pat. No. 6,476,952 describes an alternative hardware security technique based on encryption of the optical output of a laser source with respect to the preceding digital bit optical field phase in the data stream.

This system requires a pulsed laser source and is susceptible to unauthorised parallel hardware date decryption. The speed of optical radiation and the data-bit temporal period restrict the tuning range of the interferometer used at the receiver, requiring a laser source of sufficient coherence length with respect to the delay period between the two arms in the interferometer used at the receiver. The pulsed signal provides an unauthorised observer with a clocked signal to experiment with and the coherent properties of the optical carries wave assist the unauthorised observer in recording and interrogating the signal in real time.

WO95/02802 describes a fibre optic sensor system for making measurements of strain or temperature variations. WO95/02802 describes the use of interferometric techniques based on the selective wavelength coherence properties of the optical source employed and the alteration of the physical properties of a fibre optic transducer by the measurand. Instrumentation interferometer techniques employ narrow waveband selective optical components and require a high degree of insulation against environmental noise because of their sensitivity. They rely upon tuned narrow waveband optical elements to perform wavelength division multiplexing to achieve this immunity.

It is an object of the present invention to provide an improved secure data communications system.

In accordance with a first aspect of the present invention there is provided an apparatus for encrypting information, the apparatus comprising:

an electromagnetic carrier signal source;
a carrier signal modulator for combining at least part of a carrier signal with the information to be encrypted;
and electromagnetic carrier signal encryption means,
wherein the electromagnetic carrier signal source is capable of providing low temporal coherence electromagnetic radiation to act as the carrier signal.

Preferably, the electromagnetic carrier signal source is a low temporal coherence source of optical radiation.

Preferably, the electromagnetic carrier signal source is a light emitting diode. More preferably the light emitting diode is superluminescent. The superluminescent light emitting diode has an optical band width of more than 40 nanometres centred at 1550 nanometres.

Optionally, infra-red, visible or ultra-violet spectral radiation may be used as the carrier signal.

Preferably, the carrier signal modulator is a phase modulator.

Preferably, the carrier signal modulator is provided with reference signal creation means, the reference signal being created from the electromagnetic carrier signal source.

Preferably, the reference signal creation means is adapted to split the carrier signal.

Optionally, the reference signal creation means is provided by a fibre optic coupler.

Optionally, the reference signal creation means is provided by a polarisation insensitive beam splitter.

Preferably, the electromagnetic carrier signal encryption is a hardware key.

Preferably, the electromagnetic carrier signal encryption means is provided by optical field phase shift means of low temporal coherence radiation for encrypting the modulated data signal.

More preferably, the phase shift means is provided with temporal delay means.

Preferably, the temporal delay means is provided by a variable longitudinal phase path length control means of the carrier medium.

Preferably, the phase shift means provides dispersive or non-dispersive delays prior to transmission of the electromagnetic carrier signal.

Optionally, the carrier signal modulator and the reference signal creation means are capable of creating respective carrier signals and reference signals that are subjected to relative optical phase modulation and dispersive or non-dispersive optical delays prior to transmission from the apparatus.

Preferably, the longitudinal phase path length control means are provided by a variable length carrier medium.

Preferably, the carrier medium is a fibre optic cable. Preferably the carrier medium is a fibre optic cable or an optical medium that is transparent to the electromagnetic broadband carrier signal and is capable of transmitting both the reference carrier signal and the encrypted carrier signal.

In accordance with a second aspect of the present invention there is provided a method for encrypting information, the method comprising the steps of:

modulating at least part of an electromagnetic carrier signal with the information to be encrypted to create a combined signal; and applying carrier signal encryption to the combined signal,
wherein the electromagnetic carrier signal is low coherence electromagnetic radiation.

Preferably, the electromagnetic carrier signal is optical radiation of low temporal coherence.

Preferably, the electromagnetic carrier signal modulation is a form of phase modulation.

Preferably, the carrier signal modulation means provides for the creation of a reference signal from the electromagnetic carrier signal

More preferably, the reference signal is created prior to carrier signal modulation.

Preferably, the carrier signal is split to provide a reference signal.

Preferably, the electromagnetic carrier signal encryption is provided by phase shifting the modulated combined signal.

Preferably, the phase shift introduces a temporal delay into the modulated combined signal.

More preferably, the temporal delay equivalent to each of the necessary wavelength phase shift.

Preferably, the temporal delay is controlled by the longitudinal phase path length variation.

Preferably, the phase shift provides dispersive or non-dispersive delays prior to transmission of the electromagnetic carrier signal.

In accordance with a third aspect of the present invention there is provided a communications system comprising:

an apparatus for encrypting information, the apparatus having an electromagnetic carrier signal source; and
electromagnetic carrier signal decryption means comprising encrypted signal measurement means capable of measuring the wavelength specific phase modulation fluctuations of the carrier signal
wherein the electromagnetic a carrier signal source is capable of providing low coherence electromagnetic radiation to act as the carrier signal.

Preferably, the apparatus for encryption is that described with reference to the first aspect of the invention.

Preferably, the decryption means comprises a hardware key.

Preferably, the decryption means is provided by phase shift means.

Optionally, the phase shift means includes temporal delay means.

Preferably, the temporal delay means is provided by variable longitudinal phase path length control means of a transparent medium to the carrier signal.

Preferably, the longitudinal phase path control means are provided by a variable length carrier medium.

Preferably the carrier medium is a fibre optic cable or an optical medium that are preferably transparent to the electromagnetic broadband carrier signal and is capable of transmitting both the reference carrier signal and the encrypted carrier signal.

Preferably, the decryption means is provided with autocorrelation means having an optical transfer function applicable to the encrypted electromagnetic carrier signal, said optical transfer function being capable of generating a measurable interferogram representing the encrypted signals autocorrelation function to allow observation of the modulation of the carrier signal.

Preferably, the autocorrelation means is provided with an interferometer for recombining the encrypted electromagnetic signal with the reference signal to generate a measurable interferogram.

Preferably, the autocorrelation means measures phase modulation of the encrypted signal converting the phase modulation into intensity modulation of the interferogram.

Preferably, the measurable intensity is measured using a photodetector.

Preferably, the intensity fluctuations are measured using a photodetector of sufficient optical and electrical bandwidth.

Preferably, an optical receiver converts the temporal optical intensity fluctuations into electronic signals.

Preferably, an electronic threshold circuit for converting the electronically recorded intensity fluctuations into an electronic modulation with respect to time, that is proportional to the original electronic data at the transmitter.

Preferably, the decryption means applies the same wavelength phase shift, onto the received reference signal as is performed by the encryption unit to generate the transmitted encrypted optical signal.

In accordance with a fourth aspect of the present invention there is provided a communications method comprising the steps of:

encrypting information carried on an electromagnetic carrier signal; and
decrypting the encrypted signal by measuring the modulation of the carrier signal
wherein, the electromagnetic carrier signal is low coherent electromagnetic radiation.

Preferably, the phase of the reference signal is shifted during decryption.

Preferably, the phase shift is a temporal phase shift.

Preferably, measuring the data phase modulation present on the encrypted carrier signal comprises hardware construction of an interference signal representing the encrypted electromagnetic carrier signal's autocorrelation function, that allows determination of the data phase modulation present on the carrier signal by creating a measurable intensity modulation from the interferogram.

Preferably, measuring the modulation of the carrier signal comprises the generation of an autocorrelation function of the encrypted electromagnetic carrier signal through a measurable interferogram to allow determination of the data modulation present on the carrier signal.

Preferably, the autocorrelation function recombines the encrypted electromagnetic signal with the reference signal to generate a measurable interferogram.

Preferably, the generated intensity modulation is measured using a photodetector.

Preferably, the electromagnetic signal decryption means comprises the deciphering of the encrypted signal, interferometrically, and simultaneously converting the phase modulated data component into a recordable optical intensity modulation signal.

The encryption means provides resilient protection of the transmitted data against espionage while allowing maximum data transfer rate.

An advantage of this technique, optically, is that the data can be encoded in the instantaneous phase of the optical carrier field of the carrier signal transmitted. Therefore decryption can only occur at any instance by using both the hardware key employed, simultaneously with the unmodulated random instantaneous phase of the optical carrier field of the carrier signal at the time of encryption of the signal.

The present invention will now be described by way of example only with reference to the accompanying drawings in which:

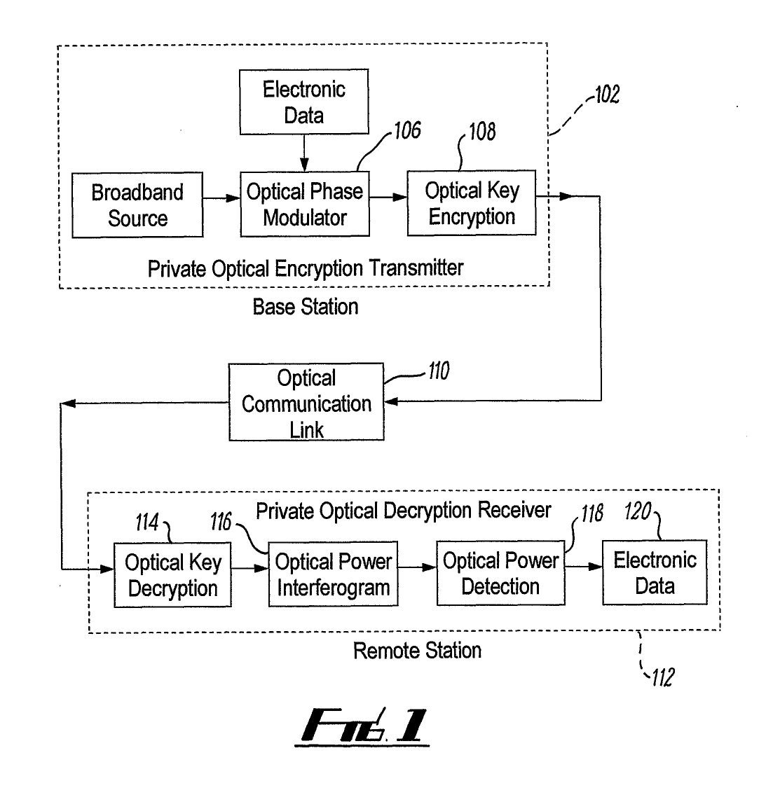

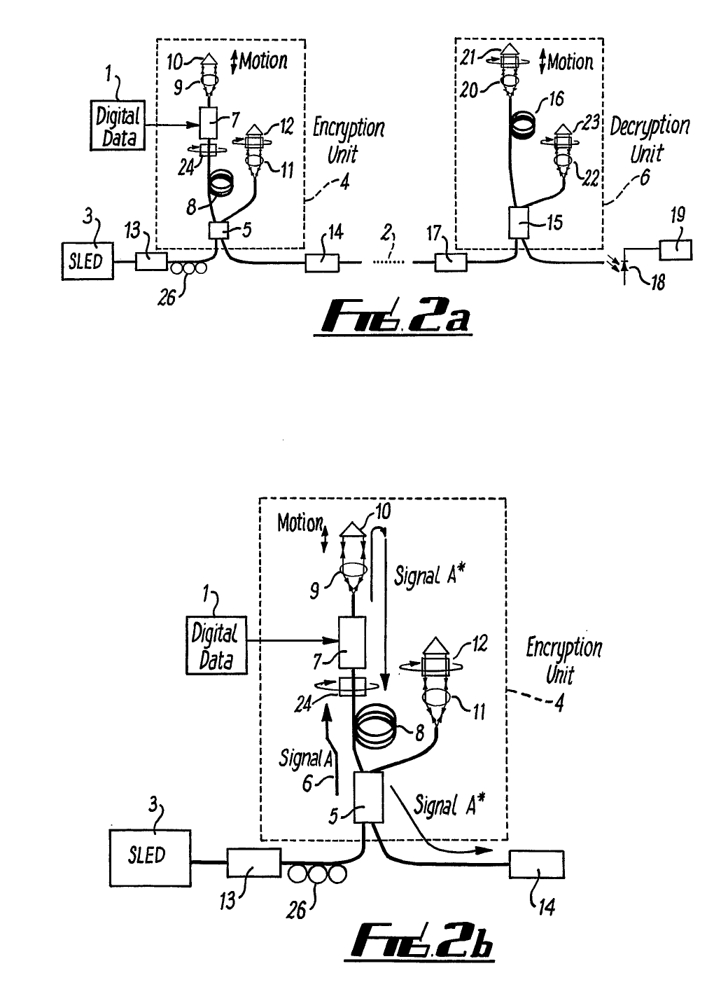

FIG. 1 illustrates schematically the implementation of an embodiment of the invention, both at the transmitter-end and receiver-end of a fibre optic communication channel;

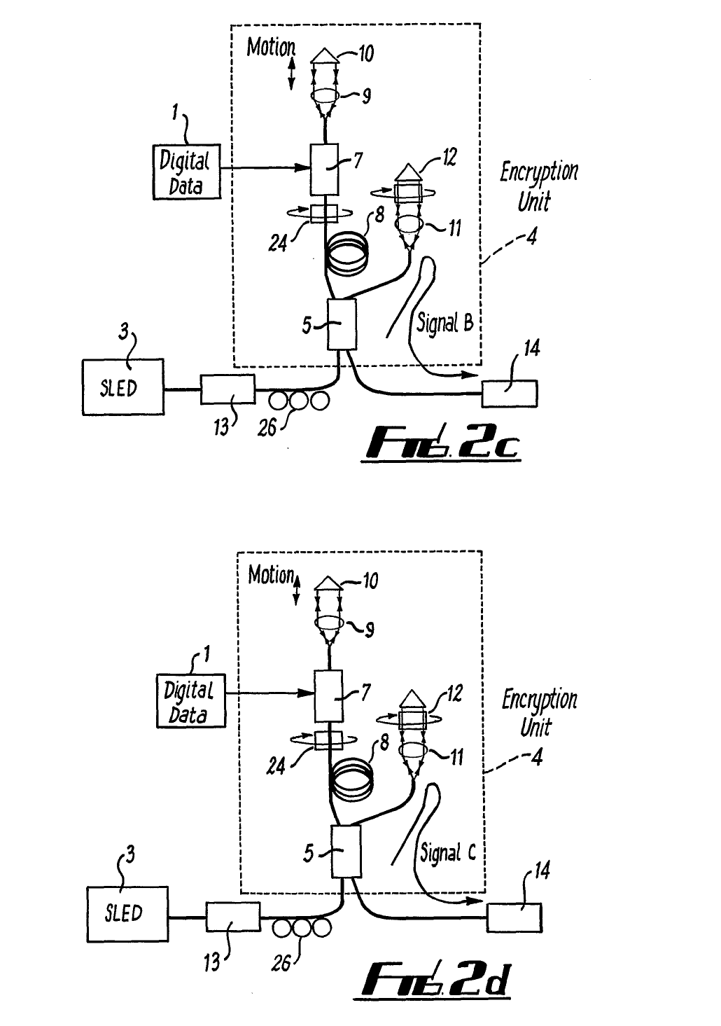

FIG. 2a shows an embodiment of the invention utilising fibre optic components to realise the encryption and decryption units, FIG. 2b shows the encryption unit along with signal paths, FIG. 2c shows the encryption unit with reference signal paths, FIG. 2d shows the encryption unit with a further reference signal path illustrated a temporal period later, FIG. 2e shows the reference signal propagation path in the decryption unit and FIG. 2f shows the encrypted signal propagation path in the decryption unit;

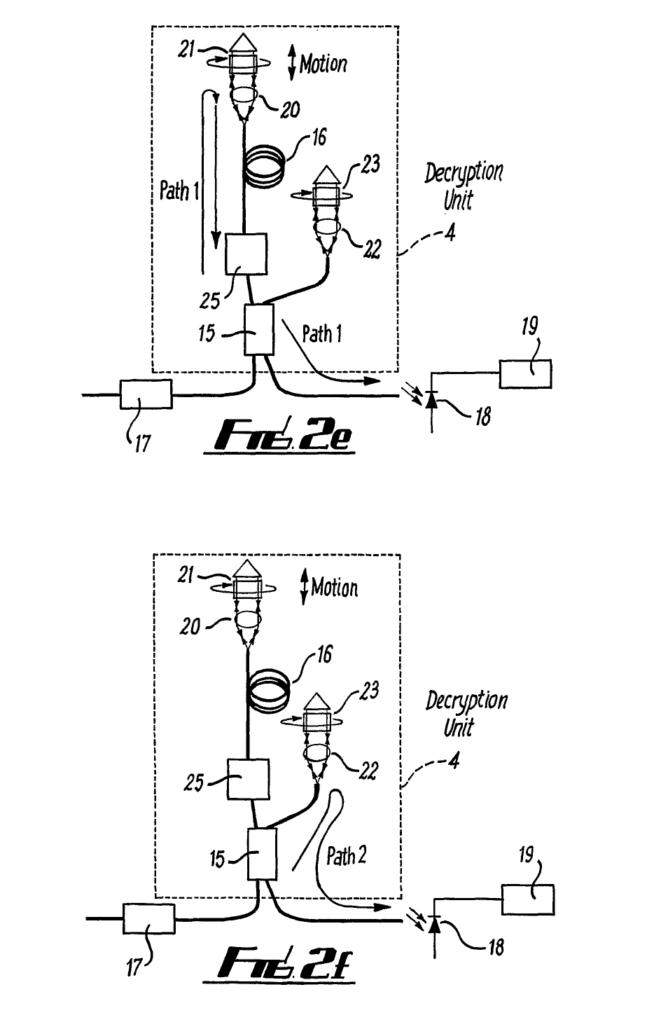

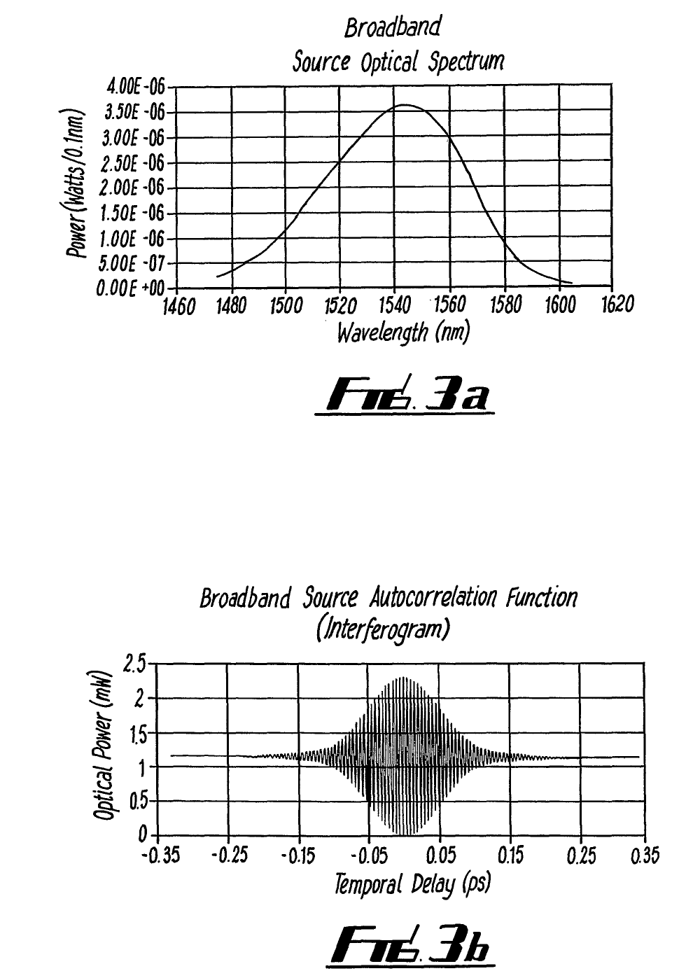

FIG. 3a shows the measured unmodulated optical broadband spectrum of a superluminescent light emitting diode (SLED) source, FIG. 3b shows the theoretical autocorrelation function (interferogram) in the spatial domain of the unmodulated optical broadband spectrum of the SLED source and FIG. 3c shows the measured results of a scanning interferogram obtained through the practical embodiment given in FIG. 2a;

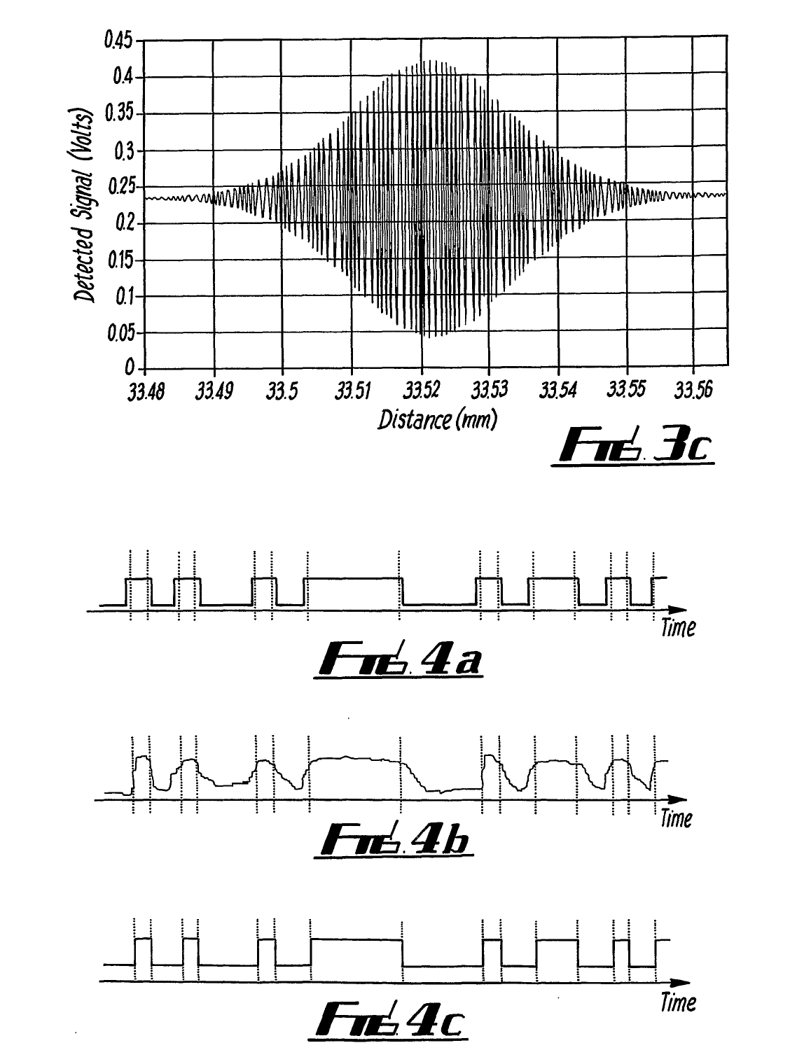

FIG. 4a shows the binary data stream applied to the phase modulator in the optical encryption unit of FIG. 2a, FIG. 4b illustrates the recorded analogue autocorrelation interferogram power variation after the decryption unit in FIG. 2a, FIG. 4c illustrates the results of threshold conversion of the fringe power variation into a binary data stream at the optical photodetector in FIG. 2a; and

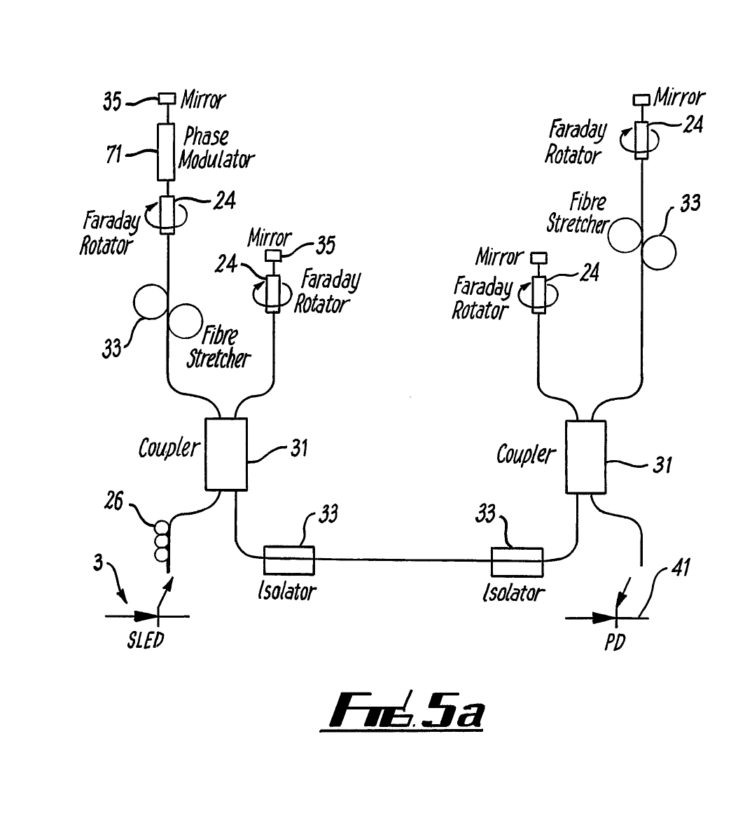

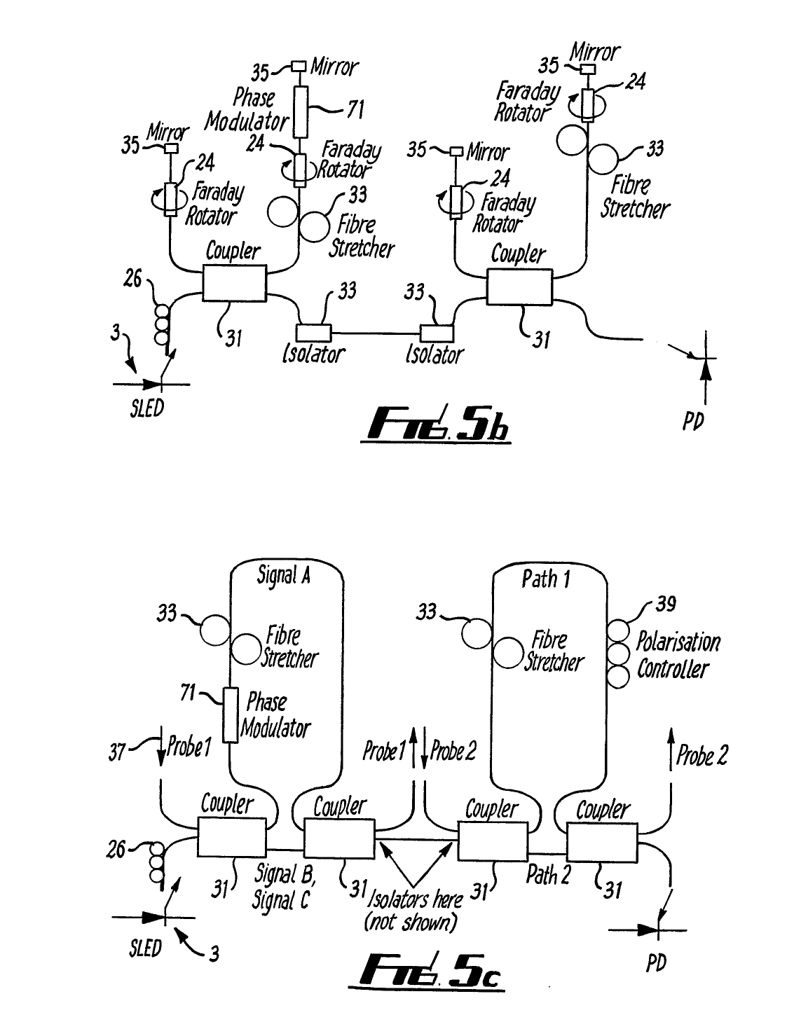

FIGS. 5a to 5c show alternative embodiments of the invention, with FIGS. 5a and 5b being similar to diagram 2b, FIG. 5c showing a closed all fibre configuration which allows a laser signal to control and monitor drift in the encryption and decryption units and FIG. 5d shows the bulk optic free space realisation of FIG. 2.

In the embodiment of the present invention disclosed below secure communication channels are provided using a dual interferometer configuration that encrypts the data optically within the optical field spectrum of the low temporal coherence transmitter output and optically decrypts the data from the encrypted optical field spectrum at the receiver.

In this example, the optical encryption unit modulates and encrypts the data to be transmitted onto the optical field spectrum of an unmodulated optical low temporal coherence source. The encryption unit achieves this by splitting the unmodulated low temporal coherence optical source output into two signals. One optical signal forms an optical reference signal spectrum, that is transmitted to the decryption unit over the communication link. The second optical signal whose complex optical field spectrum, is a replica of the optical reference spectrum, is phase modulated by the data to be transmitted, and subsequently optically encrypted.

The encryption unit performs the optical field encryption of the carrier signal by applying a predetermined temporal optical delay, or equivalent optical phase shift on the longitudinal path, to the optical spectrum of the second signal. The optically encrypted spectrum of the second signal is then transmitted to the decryption unit over the same communication link. The second signal at time of transmission over the communication link is transmitted simultaneously with, and in respect to the optical properties of the second signal at that instance, an uncorrelated incoherent signal provided by the source.

The decryption unit deciphers the optical field spectrum of the encrypted optical signal by optically processing the autocorrelation function of the encrypted optical signal to generate a measurable interferogram.

The decryption unit applies the same longitudinal path optical delay or equivalent optical wavelength phase shift and dispersion variation, onto the received optical reference signal spectrum as performed by the encryption unit on the corresponding encrypted optical signal spectrum.

Computation of the autocorrelation function is performed optically by recombining, interferometrically, the encrypted optical signal with the optical reference signal spectrum that has been temporal delay shifted, or phase shifted to generate an optical interferogram.

The data phase modulation present on the encrypted optical signal causes an intensity modulation to appear during the interferometric recombination process.

A photodetector is used to record electronically the intensity modulation to recover the original data modulation applied at the encryption unit.

The presence of identical longitudinal path delays or equivalent optical phase shifts at the encryption and decryption units determines whether optical interference between the two signals will occur and hence the existence of a discernible autocorrelation function.

The path delay or equivalent optical phase shift on the longitudinal path, being the optical encryption key. In the absence of the correct optical key in the encryption unit, the encrypted optical field spectrum of the data phase modulated optical signal will be indistinguishable from an unmodulated low temporal coherence signal, or an amplified optical noise source for instance.

Since the data to be transmitted is phase encoded in the encrypted random phase optical field of the low temporal coherence signal, decryption of the optical signal, requires possession of the hardware key at the time of reception. Otherwise the autocorrelation function cannot be realised without the correct encryption key and all optical information will be lost to an observer monitoring the communication channel.

FIG. 1 shows the subsystems utilised to realise a secure communication channel employing the encryption technique proposed here.

In FIG. 1, an optical encryption transmitter 102 low temporal coherence source 104 whose optical output spectrum will be encrypted. An optical phase modulator 106 phase modulates electronic data onto the optical spectrum of the signal emitted by the low temporal coherence optical source 104 and is connected to an encryption unit 108 which optically encrypts the phase modulated low temporal coherence optical signal through longitudinal phase path control.

A decryption unit 112 is used to decipher the encrypted data by processing the autocorrelation function 116 through control of the longitudinal phase path 114. The remaining optical phase modulated data is substantially simultaneously, through the decryption process converted into optical intensity modulation 118 in the spatial plane of the optical receiver, a receiver unit 120 is used to perform optoelectronic conversion of the said optical intensity modulation for recording the data electronically.

The present invention will be described with reference to the examples of FIGS. 2a-c and FIGS. 5a-d. FIG. 5a shows the sled 3 coupled with polarisation controller 26 and coupler 31. The fibre structure 33, Faraday rotator 24, phase modulator 71 and mirror 35. The second Faraday rotator 24 and mirror 35 is also shown in the encryption means of this example of the present invention. On transmission the signal exits through an isolator 33 and is received by isolator 33 and is decrypted in a system comprising fibres, Faraday rotators 24, a pair of mirrors 35 and fibre stretcher 33. A photo detector 41 is also shown. Similar arrangements are shown in FIGS. 5b and 5c with FIG. 5d showing a bulk optic free space example of the present invention.

FIG. 2a shows a digital data stream 1 transmitted securely over a public or private optical communication channel 2 by employing optical field encryption.

In FIG. 2 the low temporal coherence optical source 3 provides the optical carrier signal to transfer the digital data stream, optically. The low temporal coherence optical source in this embodiment being a Superluminescent Light Emitting Diode (SLED) of optical bandwidth greater than 40 nm centred at 1550 nm FIG. 3a. The SLED is unmodulated providing a constant optical power output over a broad optical wavelength band.

The optical output from the broadband source that propagates through the encryption unit 4 is split through amplitude division to provide two signals, signal A FIG. 2b and signal B FIG. 2c. This can be achieved using a fibre optic fused biconical taper coupler 5, or in a bulk arrangement through a polarisation insensitive beam splitter 51 in encryption unit 41 (FIG. 5d).

Signal B FIG. 2c and FIG. 5d is transmitted directly over the communication channel, a fibre optic link 2 in both instances, to the decryption unit 6/61.

Signal A FIG. 2b and FIG. 5d propagates along a predetermined fibre optic path length 8 or free space path length 81 (FIG. 5d). The path length introduces an optical temporal delay phase shift on the optical spectrum of signal A. This optical temporal delay phase shift could be any phase value, for example between 0 and 10¹⁰ degrees depending on the wavelength and longitudinal path involved. Signal A then passes through a 45° Faraday Rotator element 24. An additional optical phase shift, representing the digital data stream is modulated onto this. This additional optical phase modulation is realised by an optoelectronic phase modulator 7. The optical phase modulator 7 imparts an optical phase magnitude of either 0 or 90 degrees onto the optical field spectrum corresponding to a digital data bit of 0 or 1 respectively.

The two applied phase shifts, compose the optical field encrypted data, signal A*. The optical temporal delay phase shift 8 being the optical encryption key FIG. 2b. For the bulk interferometer arrangement FIG. 5d the phase modulation is achieved by deflecting mirror 81 (FIG. 5d) to alter the path length traveled. Alternatively a bulk electro-optic phase modulator could be employed with a static mirror replacing element 81 to achieve data modulation and direction of propagation reversal.

The optical field encrypted data, signal A*, direction of propagation is reversed in this embodiment by the combination of a fibre collimator lens 9 and an external bulk corner cube reflector 10 FIG. 2b. Signal A* traverses 7 and 8 in the opposite direction. Signal A* is coupled 5 onto and transmitted over the communication channel 2. Signal B FIG. 2c direction of propagation is similarly reversed by a combination of a fibre collimator lens 11 and a combination of a 450 Faraday Rotator and an external bulk corner cube reflector 12.

A passive technique for compensating cumulative fibre birefringence weakening the systems optical signal coherency at the photo detector FIG. 1 118 positioned 45° Faraday Rotators 24, 12, 21, 23 prior to all path reversal elements in the fiber embodiments. Faraday Rotator 24 was placed prior to the phase modulator 7 at the encryption unit due to the modulator 7 having the properties of a polariser element. A polarisation controller 26 can be inserted between 13 and 5 FIG. 2b to maximise the optical power throughput of the modulator 7 and hence maximise the fringe visibility at the photodetector 18.

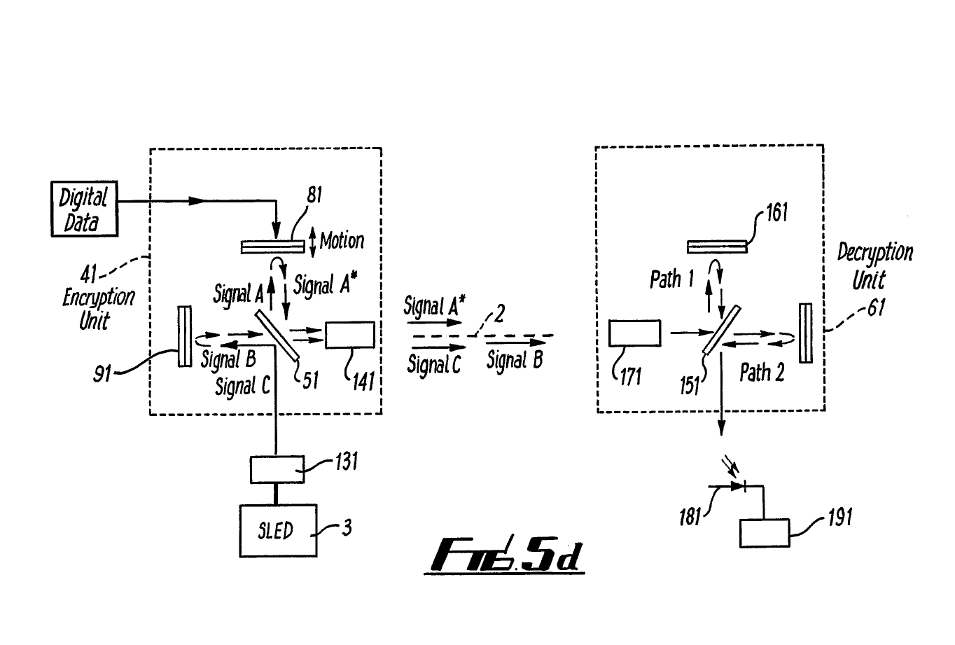

In FIG. 5d mirror 91 reverses the path of signal A and at the same time encrypts the optical field of signal A to produce signal A*. An optical isolator 13, FIGS. 2b and 131 FIG. 5d, proceeding the SLED 3 prevents unwanted optical instabilities generating noise in the source from reversed signal coupling, signal A* and signal B, back into the source. Optical isolator 14/141 prevents interrogation of the optical key 7, FIGS. 2b and 5d by a hostile external laser source.

The optical communication link 2 at any instance in time at any spatial point along its path contains two signals due to the broadband source emitting a constant optical power output. A temporal delayed spectral phase modulated signal, signal A*, and an independent (with respect to signal A* and signal B) optical source signal, signal C, FIG. 2d that is transmitted by the broadband source a temporal period later (the temporal period being equivalent to the temporal path delay seen by the modulated signal A before reaching the optical communication link) and follows the path of signal B, both propagating simultaneously over the optical communication link 2.

Signal C in FIG. 5d follows the same path as signal B. Isolator 171 prevents interrogation of the decryption unit by a hostile probe signal in FIG. 2e.

The optical signals transmitted over the optical communication link 2 that reach the decryption unit 6 are split in power 15. One part of the optical signal follows Path 1 the remaining part follows path 2 FIG. 2e and FIG. 2f. The temporal delay period 16, used by the decryption unit is of equal duration to the temporal delay employed at the transmitter 7.

The component of Signal B that traverses Path 1 FIG. 2e interferes, a temporal delay period later, with the then arriving split signal A*, that has traversed path 2 FIG. 2f, at the photodetector 18. Path 2 being equal to the corresponding path in the encryption unit that generated signal B.

The component of Signal B that traverses Path 1 FIG. 5d interferes, a temporal delay period later, with the then arriving split signal A*, that has traversed path 2 FIG. 5d, at the photodetector 18. Path 2 being equal to the corresponding path in the encryption unit that generated signal B.

As components of signal A* and signal B were both derived from the same original optical field fluctuation at the broadband source and have subsequently undergone identical temporal delay shifts, they will be coherent in phase with respect to each other when they interfere at the photodetector 18.

All other components of signal A*, signal B and signal C that traversed different paths (FIG. 2b to FIG. 2f) or were emitted at a different instance in time by the source interfere incoherently to produce background noise. The optically coherent interference occurring at the photodetector produces an optical interferogram that can be monitored by the photodetector FIG. 3b.

All other components of signal A*, signal B and signal C that traversed different paths (FIG. 5d) or were emitted at a different instance in time by the source interfere incoherently to produce background noise. The optically coherent interference occurring at the photodetector produces an optical interferogram that can be monitored by the photodetector FIG. 3b.

The optical phase modulation applied to signal A, causes the interferogram fringes generated by signal A* and signal B at the decryption unit to alter position with respect to the applied optical phase modulation magnitude, FIG. 3c. This variation in the fringe positioning causes a power variation recordable by the photodiode. The original data stream can be recovered electronically using a threshold detector 19 FIG. 2.

The interferogram intensity, I(l) (FIG. 3b), measured by a photodetector for light of spectral distribution, B(σ), after traversing an interferometer can be calculated through equation 1,

$$I ( l ) = {\int }_{0}^{∞} B ( σ ) ( 1 + cos ( 2 π σ l ) ) d σ \qquad equation 1$$

where σ is the wavenumber, cm⁻¹, 1 is the path delay between the two arms. The measurand, I(l), being the intensity monitored at a particular delay length l, FIG. 3b. Equation 1 is also a representation of the autocorrelation function of the source. Equation 1 may be evaluated computational using discrete Fourier transform theory.

The envelope profile of the interferogram FIG. 3b constructed over path delay length, l, is determined by the centre wavelength, spectral width and spectral power distribution of the broadband source.

The coherence properties of the broadband source spectrum FIG. 3a determine the width of the interferogram FIG. 3b in reciprocal space, through equation (2) approximately.

$$Δ l = \frac{{λ}^{2}}{Δλ} \qquad equation 2$$

The resulting intensity variation within the envelope profile can be quantified through the fringe visibility function equation (3)

$$v ( l ) ≡ \frac{{I}_{max} - {I}_{min}}{{I}_{max} + {I}_{min}} \qquad equation 3$$

The threshold detection levels for a 1 and a 0 bit can be programmed for waveform FIG. 4b within the threshold detection circuitry to generate waveform 4c.

Environmental temperature drift and disturbances can be compensated by employing a low frequency, with respect to the data transmission rate, feedback control loop between the photodetector 18 and a piezo fiber stretcher located in one fiber path of the decryption unit 25. The feedback control loop ‘lock’ position being determined by a preset average optical power monitor.

By maintaining lock on the detected signal through an average power monitor of fringe maxima, FIG. 3b the necessary environmental compensation for the practical embodiment of FIG. 2a can be realised.

The environmental compensation functionality allows for tuning and temperature compensation of drift in the system between the encryption and decryption unit. FIG. 4c shows the results obtained through the practical embodiment FIG. 2.

Alternative embodiments could realise the longitudinal delay paths through a closed fibre optic circuit through a tapped delay feedforward or feedback configuration (FIG. 5a to 5c). The single branch couplers in FIG. (5a to 5c) could be replaced by Micro Electromechanically Machined devices to allow digital control of longitudinal delay paths through multiple branch interconnected loops that are switchable.

The optical field encryption technique presented here could incorporate time division multiplexing and/or wavelength division multiplexing and/or multilevel data modulation techniques to enhance system data bandwidth.

Improvements and modifications may be incorporated herein without deviating from the scope of the invention.

1. An apparatus for encrypting information, the apparatus comprising:
an electromagnetic carrier signal source;
a carrier signal modulator for combining at least part of a carrier signal with the information to be encrypted;
and electromagnetic carrier signal encryption means,
wherein the electromagnetic carrier signal-source is capable of providing temporal low coherence electromagnetic radiation to act as the carrier signal.

2. An apparatus as claimed in claim 1 wherein the electromagnetic carrier signal source is a low temporal coherence source of optical radiation.

3. An apparatus as claimed in any preceding claim wherein the carrier signal modulator is a phase modulator.

4. An apparatus as claimed in any preceding claim wherein the carrier signal modulator is provided with reference signal creation means, the reference signal being created from the electromagnetic carrier signal source.

5. An apparatus as claimed in claim 4 wherein, the reference signal creation means is adapted to split the carrier signal.

6. An apparatus as claimed in any of claims 3-5 wherein, the reference signal creation means is provided by a fibre optic coupler.

7. An apparatus as claimed in any preceding claim wherein, the electromagnetic carrier signal encryption means is a hardware key.

8. An apparatus as claimed in any preceding claim wherein, the electromagnetic carrier signal encryption means is provided by optical field phase shift means of incoherent radiation for encrypting the modulated data signal.

9. An apparatus as claimed in claim 8 wherein, the phase shift means is provided with temporal delay means.

10. An apparatus as claimed in claim 12 wherein, the temporal delay means is provided by a variable longitudinal phase path length control means of the carrier medium.

11. An apparatus as claimed in claim 8 wherein, the optical field phase shift means provides dispersive or non-dispersive delays prior to transmission of the electromagnetic carrier signal.

12. An apparatus as claimed in claim 11 when dependent upon claim 4 wherein, the carrier signal modulator and the reference signal creation means are capable of creating respective carrier signals and reference signals that are subject to relative optical phase modulation and dispersive or non-dispersive optical delays prior to transmission.

13. An apparatus as claimed in claim 10 wherein, the longitudinal phase path length control means are provided by a variable length carrier medium.

14. An apparatus as claimed in claim 13 wherein, the carrier medium is a fibre optic cable.

15. An apparatus as claimed in claim 13 or claim 14 wherein, the carrier medium is an optical cable or an optical medium transparent to the electromagnetic broadband carrier signal, and is capable of transmitting both the reference carrier signal and the encrypted carrier signal.

16. A method for encrypting information, the method comprising the steps of:
modulating at least part of an electromagnetic carrier signal with the information to be encrypted to create a combined signal; and applying carrier signal encryption to the combined signal,
wherein the electromagnetic carrier signal is low temporal coherence electromagnetic radiation.

17. A method for encrypting information as claimed in claim 16 wherein, the electromagnetic carrier signal is optical radiation of low temporal coherence.

18. A method for encrypting information as claimed in claim 16 or claim 17 wherein, the electromagnetic carrier signal modulation is a form of phase modulation.

19. A method for encrypting information as claimed in any of claims 16 to 18 wherein, carrier signal modulation provides for the creation of a reference signal from the electromagnetic carrier signal prior to modulation.

20. A method for encrypting information as claimed in any of claims 16 to 19 wherein, the carrier signal is split to provide a reference signal.

21. A method for encrypting information as claimed in any of claims 16 to 20 wherein, the electromagnetic carrier signal encryption is provided by phase shifting the modulated combined signal.

22. A method for encrypting information as claimed in claim 21 wherein, the phase shift introduces a temporal delay into the modulated combined signal.

23. A method for encrypting as claimed in claim 22 wherein the temporal delay is equivalent to each of the necessary wavelength shifts.

24. A method for encrypting information as claimed in claim 22 wherein, the temporal delay is controlled by the longitudinal phase path length variation.

25. A method for encrypting information as claimed in any of claims 21 to 24 wherein, the phase shift provides dispersive or non-dispersive delays prior to transmission of the electromagnetic carrier signal.

26. A communications system comprising:
an apparatus for encrypting information, the apparatus having an electromagnetic carrier signal source; and
electromagnetic carrier signal decryption means comprising encrypted signal measurement means capable of measuring the wavelength specific phase modulation fluctuations of the carrier signal,
wherein the electromagnetic carrier signal source is capable of providing low temporal coherence electromagnetic radiation to act as the carrier signal.

27. A communications system as claimed in claim 26 wherein the apparatus for encrypting information is as claimed in any of claims 1 to 15.

28. A communications system as claimed in claim 26 or 27 wherein the decryption means comprises a hardware key.

29. A communications system as claimed in claims 26 to 28 wherein, the decryption means is provided by phase shift means.

30. A communication system as claimed in claim 29 wherein, the phase shift means includes temporal delay means.

31. A communications system as claimed in claim 30 wherein, the temporal delay means is provided by variable longitudinal phase path length control means of a transparent medium to the carrier signal.

32. A communications system as claimed in claim 31 wherein, the longitudinal phase path control means are provided by a variable length carrier medium.

33. A communications system as claimed in claim 32 wherein, the carrier medium is a fibre optic cable.

34. A communications system as claimed in any of claims 26 to 33 wherein, the decryption means is provided with autocorrelation means having an optical transfer function applicable to the encrypted electromagnetic carrier signal, said optical transfer function being capable of generating a measurable interferogram representing the encrypted signals autocorrelation function to allow observation of the modulation of the carrier signal.

35. A communications system as claimed in claim 34 wherein, the autocorrelation means is provided with an interferometer for recombining the encrypted electromagnetic signal with the reference signal to generate a measurable interferogram.

36. A communications system as claimed in claim 34 or 35 wherein, the autocorrelation means measures phase modulation to create measurable intensity modulation on the interferogram.

37. A communications system as claimed in claim 35 wherein, the measurable intensity is measured using a photodetector.

38. A communications system as claimed in claims 26 to 37 further comprising an electronic threshold circuit for converting the electronically recorded intensity fluctuations into an electronic modulation with respect to time, that is proportional to the original electronic data at the transmitter.

39. A communications method comprising the steps of:
encrypting information carried on an electromagnetic carrier signal; and
decrypting the encrypted signal by measuring the modulation of the carrier signal
wherein, the electromagnetic carrier signal is low temporal coherence electromagnetic radiation.

40. A communications method as claimed in claim 39 wherein the step of encrypting information carried on an electromagnetic carrier signal is as described with reference to claims 16 to 25.

41. A communications method as claimed in claim 39 or 40 wherein the decryption method shifts the phase of a reference signal is shifted during decryption.

42. A communications method as claimed in claims 39 to 41, wherein the phase shift is a temporal phase shift.

43. A communications method as claimed in claims 39 to 42 wherein, measuring the data phase modulation present on the encrypted carrier signal comprises real time hardware construction of an interferogram proportional to the encrypted electromagnetic carrier signal's autocorrelation function, that allows determination of the data phase modulation present on the carrier signal by creating a measurable intensity modulation on the interferogram.

44. A communications method as claimed in claims 38 to 43 wherein, measuring the modulation of the carrier signal comprises the generation of an autocorrelation function applicable to the encrypted electromagnetic carrier signal providing a measurable interferogram to allow determination of the data modulation present on the carrier signal.

45. A communications method as claimed in claim 44 wherein, the autocorrelation means recombines the encrypted electromagnetic signal with the reference signal to generate the measurable interferogram.

46. A communications method as claimed in claim 45 wherein, the measurable interferogram intensity is measured using a photodetector.

47. A communications method as claimed in claims 38 to 46 wherein, the electromagnetic signal decryption means deciphers the encrypted signal interferometrically, while simultaneously converting the phase modulated data into a recordable optical intensity modulation signal.
